(19) United States
(12) Patent Application Publication
(10) Pub. No.: US 2006/0138716 A1
(43) Pub. Date: Jun. 29, 2006

(54) Method for producing a ceramic crucible

(76) Inventors: Martin Schluter, Bremen (DE); Thomas Wiest, Hunfeld (DE); Stephan Dierkes, Bremen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/304,757

(22) Filed: Dec. 16, 2005

(30) Foreign Application Priority Data
Dec. 17, 2004 (DE) 102004060792.3-45

(51) Int. Cl. B01L 3/00; C21B 3/00; C04B 35/64

(52) U.S. Cl. 264/681; 266/275; 422/102

(57) ABSTRACT

The invention relates to a method for producing a ceramic crucible. The following steps are proposed: providing a solidifiable slip, providing a casting mould (10) for the ceramic crucible, pouring the slip into the casting mould, solidifying the slip in the casting mould by (a) freezing and/or (b) changing its pH value, such that a preform is obtained, and heat-treating the preform, such that a ceramic crucible is obtained. The invention additionally relates to a ceramic crucible producible using such a method and a kit for producing such a ceramic crucible, having: (a) a casting mould, preferably a metal mould, for a ceramic crucible,

(b) a sol, preferably an aqueous SiO₂ sol, comprising a ceramic nanoparticle fraction, (c) ceramic particles comprising a microceramic fraction, (d) optionally a metal powder consisting essentially of metals and/or alloys and/or intermetallic compounds, (e) optionally one or more further additives and optionally organic or inorganic binders. Finally, the invention relates to an apparatus for performing the stated method.

### FIELD OF THE INVENTION

The invention relates to a method for producing a ceramic crucible. Furthermore, the invention relates to a ceramic crucible, a kit for producing a ceramic crucible and an apparatus for performing a method for producing a ceramic crucible.

### BACKGROUND OF THE TECHNOLOGY

It is known to produce ceramic crucibles by pouring a slip into a porous, absorbent plaster mould. The slip comprises suspending fluid, which is absorbed by the absorbent plaster mould. Through extraction of the suspending fluid, a ceramic layer forms on the wall of the plaster mould, which continues to build up until the desired layer thickness of the ceramic layer is reached, whereupon the resultant green body is de-moulded and then sintered, producing a ceramic crucible.

According to one variant, a hollow casting plaster mould is used as the plaster mould. Once the slip has been poured in and the desired wall thickness has-been reached for the resultant green body, the super-fluous slip is poured away. In this instance too, the green body obtained is then demoulded and sintered.

A disadvantage of this method is that the plaster mould used is complex to produce and can only be used to produce a limited number of ceramic crucibles. This makes known methods relatively cost-intensive.

In addition, as the plaster mould ages changes occur to the crucible geometry and surface, such that the ceramic crucibles produced exhibit only poor dimensional accuracy. Poor dimensional accuracy means that ceramic crucibles produced by the same method may differ greatly in their geometric dimensions from one another and from the average geometric dimensions of the ceramic crucibles produced. Poor dimensional accuracy is therefore synonymous with such a method exhibiting poor reproducibility with regard to the ceramic crucibles produced. If a method exhibits poor reproducibility, it is impossible to achieve small dimensional tolerances. Dimensional tolerance is the admissible deviation for a geometric dimension.

Furthermore, the methods according to the prior art do not allow the achievement of small shape tolerances. If small shape tolerances are specified, the only ceramic crucibles which are accepted as good parts are those which exhibit only a specified geometric deviation from a specified geometric shape (shape tolerance), the remainder being rejected. This means that ceramic crucibles which are produced in accordance with a prior art method using the same casting mould and otherwise under the same method conditions may differ so markedly in their geometric dimensions from the set geometric shape that a large proportion are rejected.

Ceramic crucibles produced using methods according to the prior art additionally exhibit an uneven surface, which is disadvantageous with regard to subsequent use. A further disadvantage is that the wall thickness may vary from place to place, which contributes to poor shape accuracy.

General reference may be made to the following documents with regard to the prior art: U.S. Pat. No. 5,811,171 (Osborne et al), which relates to ceramic products; EP 0 016 971 B1 (Blasch Precision Ceramics, Inc.), which relates to a method of freezing inorganic, particulate, aqueous slurries or suspensions; U.S. Pat. No. 3,512,571 (Phelps), which relates to cryogenic formation of refractory moulds and other foundry articles; U.S. Pat. No. 3,885,005 (Downing et al), which relates to the production of refractory articles using a freeze casting method; DE 39 17 734 A1 (Hoechst AG), which relates to a method of producing ceramic shaped articles by freezing aqueous slips. In addition, reference may be made to document DE 103 35 224 A1 (University of Bremen), which was published on 24th Mar. 2005 and relates to a method and a slip for producing a shaped article from ceramic material, a ceramic shaped article and the use of such a shaped article, but makes no reference to the production of a ceramic crucible; publication WO 2005/012205 (University of Bremen) corresponds to the stated document.

### SUMMARY OF THE INVENTION

It is the object of the present invention to overcome or at least alleviate the disadvantages of the prior art.

The invention solves the problem according to a first aspect with a method for producing a ceramic crucible having the following steps
providing a solidifiable slip,
providing a casting mould for the ceramic crucible,
pouring the slip into the casting mould,
solidifying the slip in the casting mould by (a) freezing, (b) changing its pH value and/or (c) adding organic or inorganic binders, such that a preform is obtained, and
heat-treating the preform, such that a ceramic crucible is obtained.

The invention solves the problem according to a second aspect with a ceramic crucible which may be produced, preferably is produced, using a method according to the invention, preferably a preferred embodiment of the method.

The invention solves the problem according to a third aspect with a kit for producing a ceramic crucible having:

(a) a casting mould, preferably a metal mould, for a ceramic crucible,

(b) a sol, preferably an aqueous SiO₂ sol, comprising a ceramic nanoparticle fraction,

(c) ceramic particles comprising a microceramic fraction,

(d) optionally, a metal powder, comprising or consisting essentially of metals and/or alloys and/or intermetallic compounds,

(e) optionally, one or more further additives and

(f) optionally, organic or inorganic binders.

Finally, the invention solves the problem according to a fourth aspect with an apparatus for performing a method according to the invention, having a casting mould for at least one ceramic crucible and a dispensing device which may be brought into connection with a storage tank for a slip to deliver the slip into the casting mould, said apparatus comprising means for cooling the casting mould to below the freeze-hardening temperature of the slip and/or means for apportioning an acid or a base to the slip and/or means for adding organic or inorganic binder to the slip, means for removing from the casting mould a preform obtained from the slip by solidification and means for heat-treating the preform.

An advantage of the invention (in its various aspects) is that the casting moulds to be used are easy and cheap to produce and may be used to produce a virtually unlimited number of ceramic crucibles. This makes cost-effective manufacture possible. In addition, small dimensional tolerances may be achieved, i.e., as explained above, two ceramic crucibles produced using a method according to the invention differ only slightly in their dimensions. In addition, it is advantageous that a high degree of shape accuracy and thus small shape tolerances may be achieved. This means that two ceramic crucibles produced using a method according to the invention differ only slightly in shape. A further advantage is that smooth surfaces may be achieved.

### BRIEF DESCRIPTION OF THE FIGURES

FIG. 1 shows a casting mould for use in a method according to a practical example of the invention.

### DETAILED DESCRIPTION OF THE INVENTION

Ceramic crucibles according to the invention or produced according to the invention may be such that they exhibit good resistance to thermal cycling, good fracture strength and resistance to thermal shock, low crucible surface wettability by metallic melts, high chemical resistance to metallic melts, low porosity and/or precise geometry.

Low wettability is achieved if the slip comprises sparingly wetting ceramic materials, such as for example silicon nitride or boron nitride. High chemical resistance to metallic melts is achieved, for example, in that the slip contains zirconium dioxide.

Preforms obtained by the method according to the invention through solidification of the slip additionally exhibit high green strength and good handling characteristics.

A ceramic crucible should be understood to mean a vessel of ceramic material. In particular, the present invention relates to ceramic crucibles which are suitable for melting metals or alloys (in particular in dental technology). Such metals or alloys generally exhibit melting points of over 500° C. The invention additionally relates in particular to ceramic crucibles for thermogravimetry.

The wall thickness of a ceramic crucible according to the invention (a) for melting metals/alloys or (b) for thermogravimetry preferably amounts to less than 8 mm and the volume to less than 500 ml. The ceramic crucible's thermal shock resistance and resistance to metallic melts is preferably so great that it is not subject to any significant loss of strength, in particular it does not crack, when molten metal at a temperature of 500° C. is suddenly poured into it.

The casting mould preferably consists of or comprises material with a thermal conductivity of over 10 W/K·m at 23° C. and 1013 hPa (e.g. metal, see below) and/or plastics and/or rubber products and/or silicones. An advantage of using casting moulds with materials with the stated thermal conductivity is that temperature equalisation takes place rapidly between the slip located in the casting mould and the surrounding environment. If the slip is solidified by freezing for example, in this way the time it takes to freeze the slip fully may be reduced. An advantage of using plastics material is its low price, such that appropriate casting moulds may be produced cheaply. An advantage of using rubber products and silicones is their resilience, which simplifies demoulding of the preform.

Heat treatment should be understood to be a method which brings about an irreversible change in the mechanical or material properties of the preform through exposure to heat. Examples of heat treatment are: sintering, dense sintering, partial sintering, reacting at elevated temperature, reaction sintering.

The method optionally comprises one or more of the following steps: demoulding of the preform prior to heat treatment and/or drying of the preform after demoulding, preferably at 40° C. to 100° C. and/or a relative atmospheric humidity of under 30%.

A method is preferred in which the solidifiable slip is a freeze-castable slip.

A slip is considered freeze-castable if it is initially liquid at one temperature (starting temperature) and solidifies on cooling to below a specified temperature (freeze-hardening temperature) to the extent of supporting its own weight (provided that the wall thickness is sufficiently large), leaving behind on subsequent reheating to the starting temperature a preform whose strength is high enough for it (to continue) to support its own weight. The freeze-hardening temperature is below the freezing point of the dispersing agent of the slip, for example between −200° C. and 0° C.

A slip is preferably used whose suspending fluid is water. When the slip freezes, ice crystals arise. After drying, pores are to be found at the points at which ice crystals are located. Ceramic crucibles produced by such a method are distinguished by greater thermal shock resistance than ceramic crucibles produced using conventional methods.

If solidification is effected by freezing, the method according to the invention additionally preferably comprises the steps of: varying the freezing conditions such as in particular the cooling rate, freezing temperature, freezing direction and thermal conductivity of the casting mould and the composition of the solidifiable slip, determining the thermal shock resistance of the ceramic crucible produced and determining the optimum freezing conditions and the optimum composition for achieving the highest possible thermal shock resistance. Thermal shock resistance is determined by pouring metallic melts at various temperatures into a ceramic crucible exhibiting a temperature of 25° C. Thermal shock resistance is characterized by the highest temperature at which the ceramic crucible still does not crack.

Alternatively, a slip is used which may be solidified by varying the pH value. For solidification purposes the pH value of the slip is then varied for example by adding an acid or base.

According to an advantageous further development of the method, the solidifiable slip is poured into a hollow casting mould, whose temperature is and is optionally held below the freeze-hardening temperature of the slip. The casting mould is preferably moved in such a way that a uniformly thick ceramic layer is deposited on the casting mould.

A method is preferred in which the casting mould consists of metal at least at certain points which are in contact with the freeze-castable slip on freezing. Metals are preferred which exhibit elevated thermal conductivity. Elevated thermal conductivity is understood to mean a conductivity of over 150 W/K·m at 23° C. and 1013 hPa. Preferred metals are aluminium, copper and stainless steel.

It is particularly preferable for the casting mould to comprise, or more especially, consist essentially of, metal.

A method is preferred in which provision of the solidifiable slip comprises the production of a mixture of:

(a) a dispersing agent,

(b) ceramic particles comprising
(i) 2 to 74 vol. % relative to the volume of the overall mixture of a ceramic nanoparticle fraction exhibiting an average particle diameter of less than 500 nm, and
(ii) 2 to 74 vol. % relative to the volume of the overall mixtureof a ceramic microparticle fraction exhibiting an average particle diameter of over 500 nm to 500 μm,

(c) optionally, a metal powder, consisting of metals and/or alloys and/or intermetallic compounds,

(d) optionally, one or more further additives and

(e) optionally, organic or inorganic binders.

If the slip is solidifiable by varying its pH value, a slip may alternatively be used which comprises the above constituents with the exception of the ceramic nanoparticle fraction.

The dispersing agents used are for example water, an alcohol or an aqueous or alcoholic mixture of liquids, which optionally comprise wetting agents and/or stabilisers and/or antimicrobial active substances. Water is preferred as dispersing agent.

The stated diameters of the particles are those which are determined to ISO 13320-1, e.g. using the Beckman Coulter GmbH LS-13320 apparatus. The proportion of the ceramic particles in vol. % is determined, for example, using the Coulter LS 230 particle size analyser made by the Coulter Corporation, Miami, Fla., U.S.A. The solids content of the slip is adapted for this purpose to the analysis range of the equipment.

A method is particularly preferred in which the slip is produced by:

(a) providing a sol comprising the ceramic nanoparticle fraction,

(b) mixing the sol with the ceramic microparticle fraction,

(c) optionally adding a metal powder, comprising or consisting essentially of, metals and/or alloys and/or intermetallic compounds,

(d) optionally mixing with one or more further additives, and

(e) optionally mixing with organic or inorganic binders.

The sol is optionally additionally mixed with ceramic nanoparticle fraction exhibiting an average diameter of less than 500 nm and preferably comprising or consisting essentially of one, two or more ceramic compounds selected from the group consisting of: aluminium oxide, mullite, spinel, zirconium dioxide, magnesium oxide, silicon dioxide. The sol can be produced, for example, by acidifying aqueous solutions of sodium silicate (Na₄SiO₄) (water glass solution). The diluted water glass solutions are passed rapidly over cation exchangers and the resulting unstable sol is stabilised by alkalization and heating, for example to 60° C. Such sols are sold by H. C. Starck or Chemiewerk Bad Kostritz.

A preferred method is one in which the ceramic nanoparticle fraction takes the form of ceramic particles of one, two or more ceramic compounds selected from the group consisting of silicon dioxide, aluminum oxide (in particular, boehmite), zirconium dioxide, yttrium oxide, one or more yttrium salts, zirconium nitrate, and titanium dioxide.

More than 60 wt.%, preferably more than 90 wt.%, of the ceramic nanoparticle fraction preferably comprises silicon dioxide.

In a preferred method, the ceramic nanoparticle fraction is present in a proportion of 2 to 30 vol. % relative to the volume of the overall mixture.

The ceramic microparticle fraction preferably comprises or consists essentially of oxides, mixed oxides, nitrides or carbides of one or more elements selected from the group consisting of lithium, beryllium, boron, sodium, magnesium, aluminum, silicon, potassium, calcium, scandium, titanium, vanadium, chromium, manganese, iron, cobalt, nickel, copper, zinc, yttrium, zirconium, niobium, molybdenum, technetium, hafnium, tin, cadmium, lead, strontium, barium, and antimony.

The ceramic particles which form the ceramic microparticle fraction particularly preferably comprise one, two or more ceramic compounds selected from the group consisting of aluminum oxide, mullite, spinel, zirconium dioxide, magnesium oxide, and silicon dioxide.

The ceramic microparticle fraction is preferably present in a proportion of 30 to 60 vol. % relative to the volume of the overall mixture.

A method is preferred wherein the metal powder comprises

(a) a powder of a metal and/or

(b) a mixture of powders of metals and/or

(c) a powder of an alloy or compound of two or more metals from the group of metals consisting of: aluminium, magnesium, zirconium, niobium, yttrium, hafnium, vanadium, calcium, potassium, tantalum, titanium, iron, silicon, germanium, molybdenum, manganese, zinc, tin, bismuth, nickel, cobalt, sodium, copper, gallium, indium and lead.

A method is additionally preferred in which

(a) the mixture contains a metal powder, a ceramic microparticle fraction, and/or one or more further additives which (i) may be reacted together and/or with gaseous reactants with an increase in volume or (ii) may be caused by thermal activation to undergo a change in the crystal lattice (phase change) and thus to increase in volume, and

(b) wherein the preform is so treated after freezing of the slip, optionally with the addition of one or more gaseous reactants and/or gas-forming reactants, that, with an increase in volume, the metal powder and/or the ceramic particles and/or one or more of the further additives react chemically or effect a phase change.

The alloy AlMg₅ is preferably used. The particle size of the metal powder is preferably 100 nm to 500 μm, particularly preferably 0.5 μm to 100 μm.

The preform is preferably treated in such a way during heat treatment that the stated reactions or phase changes occur. A method is preferred in which the metal powder and the treatment are so selected that the metal powder reacts during treatment in the solid state with an increase in volume. The metal powder is preferably embedded in the ceramics prior to treatment. Niobium may be used in this respect, for example. The reaction brings about compensation of the sinter shrinkage of the other constituents of the preform, such that overall the preform does not suffer any (or any appreciable) sinter shrinkage.

Alternatively, a method is preferred in which the metal powder and the treatment are so selected that, during treatment, the metal powder is initially liquefied (due to the selected temperature adjustments) and then reacts with an increase in volume. In this method the metal powder is initially liquefied, flows into the pores and closes them at least partially due to the increase in volume during the reaction. This reaction results in a reduction in porosity, an increase in strength and optionally also in compensation of sinter shrinkage. An example of a suitable metal powder is AlMg5. See in this respect in particular Example of application 3 below.

Examples of gaseous reactants used are O₂, N₂, CO, CO₂ or mixtures thereof.

A method is preferred in which the proportion in the slip of metal powder and/or ceramic microparticle fraction and/or the one or more additives, which react chemically or effect a phase change with an increase in volume, is selected to be such that the finished ceramic crucible deviates in its external dimensions from the corresponding internal dimensions of the casting mould in each case at 23° C. and 1013 hPa by less than 2%, preferably less than 1%.

The proportion of metal powder and/or ceramic microparticle fraction and/or the one or more additives is preferably so selected as to increase the strength of the ceramic crucible by 20% in comparison with a ceramic crucible which is produced without the stated metal powder and/or without the stated ceramic microparticle fraction and/or without appropriate additives but otherwise by the same procedure. To determine the appropriate proportion, the proportion of metal powder and/or ceramic microparticle fraction and/or the one or more additives in the slip is varied. A test specimen is then produced with this slip using a method according to the invention. The dimensions of the test specimen are so selected that a standardized 4-point bending test may be performed on this test specimen. A 4-point bending test is then performed and the strength of the test specimen is thus determined.

The proportion of metal powder and/or ceramic microparticle fraction and/or the plurality of additives is so selected on the basis of the measured data obtained by this procedure that a strength is achieved which is 20% above that of a ceramic crucible produced without the appropriate metal powder and/or without the appropriate ceramic microparticle fraction and/or without appropriate additives.

The proportion of metal powder and/or ceramic microparticle fraction and/or the one or more additives is preferably so selected that a reduction in open porosity is obtained of more than 10%, in particular more than 25%, in particular more than 50%, in comparison to a ceramic crucible which is produced without the stated metal powder and/or without the stated ceramic microparticle fraction and/or without appropriate additives but otherwise by the same procedure. Open porosity is determined using the water penetration method according to ISO/FDIS 18754.

In a preferred method, the proportion of metal powder and/or ceramic microparticle fraction and/or the additives is so selected that a specified open porosity F is obtained for the ceramic crucible.

The invention is explained in more detail below with reference to the following practical examples and the drawings.

### EXAMPLES

### Practical Example 1

A method is described below for producing a ceramic crucible according to a practical example of the present invention. An aqueous silicon dioxide sol is mixed with aluminum oxide powder and mullite powder by stirring; glycerol is added.

The median value (d₅₀) of the distribution of the diameters of the SiO₂ particles in the aqueous SiO₂ amounts to 8 nm. The diameters of the aluminum oxide powder particles are less than 10 μm and the diameters of the mullite powder particles are less than 80 μm. Such a sol is produced industrially, for example by acidifying aqueous sodium silicate solutions, passing the solution over cation exchangers and alkalizing the resultant sol. Such a sol is sold by CWK as Kostrosol 08/30.

The mixture has the composition stated in Table 1:

TABLE 1

| Material | g | wt. % |
|---|---|---|
| Mullite | 100 | 50.9 |
| Aluminium oxide | 45 | 22.9 |
| SiO₂ sol | 50 | 25.4 |
| Glycerol | 1.5 | 0.8 |
| Total | 196.5 | 100.0 |

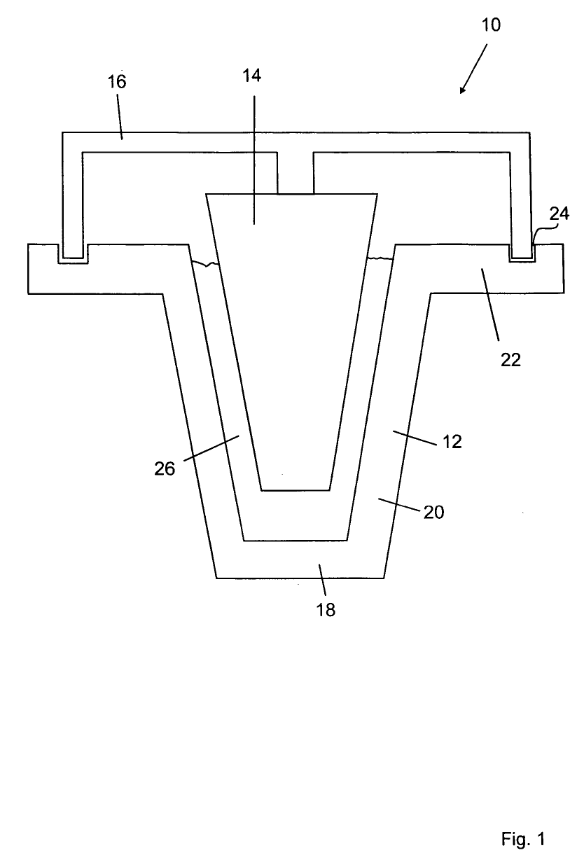

The mixture is a freeze-castable slip, i.e. a special solidifiable slip. The slip is intended for pouring into a metallic casting mould 10 (FIG. 1). The metallic casting mould 10 comprises a basic member 12 and an insert 14, which is connected detachably with the basic member 12 via an arm 16. The insert 14 has the shape of a truncated cone.

The basic member 12 comprises a bottom 18 and a side wall 20, adjoined by a rim 22. The bottom 18 and the side wall 20 form a frustoconical cavity open at the top. The aperture angle of the side wall 20 corresponds to the aperture angle of the truncated cone-shaped insert 14. The insert 14 is so oriented by the arm 16 relative to the basic member 12 that the spacing between the side wall 20 and the insert is constant.

The arm 16 is screwed tightly to the insert 14 and is thereby connected firmly but detachably therewith. The arm 16 rests on the basic member 12 in recesses 24 formed in the rim 22.

The slip (cf. reference numeral 26) is poured into the space between the basic member 12 and the insert 14. The weight of the insert 14 is selected such that the buoyancy produced by the slip 26 does not result in the insert 14 moving relative to the basic member 12 when the slip is poured in. In an alternative construction, the arm 16 is connected firmly with the basic member 12, for example by a screw or a bayonet joint.

The metallic casting mould 10, together with the slip 26 poured therein, is then put into a freezing compartment and frozen. The air temperature in the freezing compartment amounts to −40° C. and the pressure to 1013 hPa. In the freezing compartment, the metallic casting mould and the slip contained therein cool down. After a time the slip freezes and a preform is formed. The time taken for freezing is determined in preliminary tests. Depending on the thickness of the metallic casting mould and on the spacing between basic member 12 and insert 14, the freezing time is typically between 30 and 300 min.

After this time the metallic casting mould is removed from the freezing compartment. The insert 14 is then removed and the preform, produced from the slip by freezing, is removed from the metallic casting mould 10. The preform produced in this way is dried in a drying cabinet at 60° C. and 1013 hPa at 30% relative atmospheric humidity. Alternatively, the shaped article may remain in the casting mould during drying. During drying the water escapes but the preform does not collapse since freezing produces a stable framework of ceramic particles which is retained, such that the preform supports its own weight. After drying, the preform, from which the water has been removed, is left behind. The preform is then sintered for 3 hours at 1200° C., such that a ceramic crucible is obtained.

### Practical Example 2

A further practical example of a method according to the invention is described below. First of all, an aqueous SiO₂ sol is mixed with aluminum oxide, mullite and Nb powder by stirring; glycerol is added. The diameters of the aluminum oxide, mullite and SiO₂ particles are those stated in practical example 1. The diameter of the niobium particles is less than 40 μm.

TABLE 2

| Material | g | wt. % |
|---|---|---|
| Mullite | 100 | 50.4 |
| Aluminium oxide | 45 | 22.7 |
| SiO₂ sol | 50 | 25.2 |
| Glycerol | 1.5 | 0.7 |
| Nb | 2 | 1.0 |
| Total | 198.5 | 100.0 |

The slip produced in this way is poured into a metallic casting mould as in practical example 1 and frozen at −40° C. in the freezing compartment. The resultant preform is demoulded and then dried in a drying cabinet at 60° C., 1013 hPa and 30% relative atmospheric humidity. The preform is then air-sintered for 3 hours at 1200° C. During sintering the Nb powder oxidises (due to the presence of atmospheric oxygen) with an increase in volume to yield niobium pentoxide.

### Practical Example 3

A further practical example of a method according to the invention is described below. First of all an aqueous SiO₂ sol is mixed with aluminium oxide, mullite, Nb and AlMg₅ powder by stirring. The diameter of the AlMg5 powder particles is less than 80 μm. The diameters of the other particles correspond to those stated in practical example 2.

TABLE 3

| Material | g | wt. % |
|---|---|---|
| Mullite | 100 | 45.8 |
| Aluminium oxide | 45 | 20.6 |
| SiO₂ sol | 50 | 22.9 |
| Glycerol | 1.5 | 0.7 |
| Nb | 2 | 0.9 |
| AlMg₅ | 20 | 9.1 |
| Total | 218.5 | 100.0 |

The slip produced in this way is poured into a metallic casting mould as in practical example 1 and frozen at −40° C. by cryostat. The resultant preform is demoulded and then dried in a drying cabinet at 60° C., 1013 hPa and 30% relative atmospheric humidity. The preform is then firstly heated for 2h to 600° C. to 700° C. and then air-sintered for 3 hours at 1200° C. While the preform has a temperature of 600° C. to 800° C., the AlMg5 powder liquefies and oxidises with an increase in volume to yield aluminium oxide, magnesium oxide and spinel. This alternative embodiment of the method results in particularly low porosity.

The increase in volume which occurs compensates in both the alternatives for the sinter shrinkage of the other constituents, such that the preform has dimensions after sintering which deviate by less than 1% from the measurements which the preform had prior to sintering.

The above-described method according to practical examples 1 to 3 may be performed in mechanised manner by means of an apparatus according to the invention. An apparatus according to the invention comprises a dispensing device for introducing slip into a metallic casting mould, for example. Dispensing devices are for example pumps and valves, in particular solenoid valves. In addition, means are preferably provided for fixing the insert 14 relative to the basic member 12, and means for cooling the metallic casting mould 10. Examples of these are: Peltier elements or compressor refrigerators.

In addition, in the present example the apparatus according to the invention comprises means for demoulding the preform after freezing. One possible way of doing this, for example, is to make the casting mould 10 resiliently deformable. The preform is released from the casting mould by exerting upwards pressure on the bottom 18 in FIG. 1. Alternatively, the bottom may be movable relative to the rest of the casting mould.

An apparatus is also advantageously provided for turning the metallic casting mould upside down. Turning upside down causes the preform to fall out of the metallic casting mould 10. The apparatus additionally comprises means of heat-treating the preform, such as for example a kiln. Alternatively, means are provided for conveying the preform to such a kiln, for example a muffle kiln.

1. A method for producing a ceramic crucible, having the following steps:
providing a solidifiable slip,
providing a casting mould (10) for the ceramic crucible
pouring the slip into the casting mould (10),
solidifying the slip in the casting mould (10) by
(a) freezing and/or
(b) changing its pH value and/or
(c) adding organic or inorganic binders, such that a preform is obtained and
heat-treating the preform, such that a ceramic crucible is obtained.

2. A method according to claim 1, wherein the solidifiable slip is a freeze-castable slip.

3. A method according to claim 2, wherein the casting mould (10) consists essentially of metal at points which are in contact with the freeze-castable slip on freezing.

4. A method according to claim 3, wherein the casting mould (10) consists of metal.

5. A method according to claim 1, wherein the solidifiable slip comprises:
(a) a dispersing agent,
(b) ceramic particles comprising (i) 2 to 74 vol. % relative to the volume of the overall mixture of a ceramic nanoparticle fraction exhibiting an average diameter of less than 500 nm, and (ii) 2 to 74 vol. % relative to the volume of the overall mixture of a ceramic microparticle fraction exhibiting an average diameter of over 500 nm to 500 μm.

6. A method according to claim 5, wherein the slip is produced by a process comprising:
(a) providing a sol comprising said ceramic nanoparticle particle fraction,
(b) mixing the sol with said ceramic microparticle fraction.

7. A method according to claim 5, characterized in that the ceramic nanoparticle fraction takes the form of ceramic particles of one, two or more ceramic compounds selected from the group consisting of: silicon dioxide, aluminium oxide, zirconium dioxide, yttrium oxide, an yttrium salt, zirconium nitrate, and titanium dioxide.

8. A method according to claim 5, wherein more than 60 wt. % of the ceramic nanoparticle fraction comprises silicon dioxide.

9. A method according to claim 5, wherein the ceramic nanoparticle fraction is present in a proportion of 2 to 30 vol. % relative to the volume of the overall mixture.

10. A method according to claim 5, wherein the ceramic microparticle fraction comprises oxides, mixed oxides, nitrides or carbides of one or more elements selected from the group consisting of lithium, beryllium, boron, sodium, magnesium, aluminium, silicon, potassium, calcium, scandium, titanium, vanadium, chromium, manganese, iron, cobalt, nickel, copper, zinc, yttrium, zirconium, niobium, molybdenum, technetium, hafnium, tin, cadmium, lead, strontium, barium, and antimony.

11. A method according to claim 5, wherein the ceramic microparticle fraction is present in a proportion of 30 to 60 vol. % relative to the volume of the overall mixture.

12. A method according to claim 5, wherein the metal powder comprises a powder of a metal, mixture of powders of metals, and/or a powder of an alloy or compound of two or more metals from the group consisting of aluminium, magnesium, zirconium, niobium, yttrium, hafnium, vanadium, calcium, potassium, tantalum, titanium, iron, silicon, germanium, molybdenum, manganese, zinc, tin, bismuth, nickel, cobalt, sodium, copper, gallium, indium and lead.

13. A method according to claim 5, wherein the mixture contains a metal powder, a ceramic microparticle fraction, and/or one or more further additives which
a) may be reacted together and/or with gaseous reactants with an increase in volume or
b) may be caused by thermal activation to undergo a change in the crystal lattice (phase change) and thus to increase in volume, and wherein the preform is so treated after freezing of the slip, optionally with the addition of one or more gaseous reactants and/or gas-forming reactants, that, with an increase in volume, the metal powder and/or the ceramic particles and/or one or more of the further additives (i) react chemically or (ii) effect a phase change.

14. A method according to claim 13, wherein the proportion in the slip of metal powder, ceramic microparticle fraction and/or the one or more additives, which react chemically or effect a phase change with an increase in volume, is selected such that the finished ceramic crucible deviates in its external dimensions from the corresponding internal dimensions of the casting mould (10) in each case at 23° C. and 1013 hPa by less than 2%.

15. A ceramic crucible produced by the method of claim 1.

16. A kit for producing a ceramic crucible, having:
(a) a casting mould (10) for a ceramic crucible,
(b) a sol comprising
(i) a ceramic nanoparticle fraction, and
(ii) ceramic particles, comprising a microceramic fraction, optionally a metal powder, consisting of metals and/or alloys and/or inter-metallic compounds.

17. An apparatus for performing a method according to claim 1, having
a casting mould (10) for at least one ceramic crucible and
a dispensing device which may be brought into connection with a storage tank for a slip to deliver the slip into the casting mould,
means for cooling the casting mould (10) to below the freeze-hardening temperature of the slip and/or means for apportioning an acid or a base to the slip and/or means for adding organic or inorganic binder to the slip,
means for removing from the casting mould a preform obtained from the slip by solidification, and
means for heat-treating the preform.
